(19) United States
(12) Patent Application Publication
(10) Pub. No.: US 2009/0158624 A1
(43) Pub. Date: Jun. 25, 2009

(54) TRENCHER CONTROL SYSTEM

(75) Inventor: TY HARTWICK, PELLA, IA (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 12/336,187

(22) Filed: Dec. 16, 2008

Related U.S. Application Data
(60) Provisional application No. 61/008,634, filed on Dec. 19, 2007.

(51) Int. Cl. E02F 5/14; H01R 43/00

(52) U.S. Cl. 37/347; 29/825

(57) ABSTRACT

The present disclosure provides a trencher control system that is reliable and easy to service. The trencher control system according to the present disclosure includes an improved wiring layout that, in part, results in a trencher that is more reliable and also easier to repair. In one embodiment of the present disclosure, control nodes of the control system are located near the trencher components that they control. The layout of the control nodes significantly reduces the overall wiring, and particularly reduces the amount of wiring extending to and from the cab. A method of controlling a trencher remotely is also provided.

### CROSS REFERENCE TO RELATED APPLICATIONS

The present application claims priority to provisional application Ser. No. 61/008,934 filed on Dec. 19, 2007 titled Trencher Control System, the disclosure of which is hereby incorporated by reference in its entirety.

### TECHNICAL FIELD

The disclosure relates to a trencher control system and a method of controlling a trencher.

### BACKGROUND

Trencher functions are typically controlled by an operator seated within a cab of the trencher. From the cab the operator can maneuver the trencher and direct trenching operations. A typical trencher control system includes several wires connecting the cab to each of the components of the trencher. An average trencher includes 80-100 separate wires that connect the cab to trencher components. Since some trencher cabs are configured to move relative to the chassis of the trencher (e.g., raise and lower) to provide operators a better view of the trenching site during trenching, the numerous wires that connect the cab to the trencher regularly flex and are therefore prone to failure. Identifying the failed wire(s) from the group of wires can be time-consuming and difficult. The present disclosure provides an improved trencher control system.

### SUMMARY

The present disclosure provides a trencher control system that is reliable and easy to service. The trencher control system according to the present disclosure includes an improved wiring layout that, in part, results in a trencher that is more reliable and also easier to repair. In one embodiment of the present disclosure, control nodes of the control system are located near the trencher components that they control. The layout of the control nodes significantly reduces the overall wiring, and particularly reduces the amount of wiring extending to and from the cab. A method of controlling a trencher remotely is also provided.

### BRIEF DESCRIPTION OF THE DRAWINGS

FIG. 1 is a schematic view of a trencher control system in accordance with an embodiment of the present disclosure;

FIG. 2 is a perspective view of a trencher including the trencher control system of the FIG. 1;

FIG. 3 is a side view of a trencher of FIG. 2;

FIG. 4 is a top view of a trencher of FIG. 2;

FIG. 5 is an end view of a trencher of FIG. 2;

FIG. 6 is a portion of the control system of FIG. 1;

FIG. 7 is a portion of the control system of FIG. 1;

FIG. 8 is a portion of the control system of FIG. 1; and

FIG. 9 is a figure showing the wiring paths between components of the trencher system.

### DETAILED DESCRIPTION

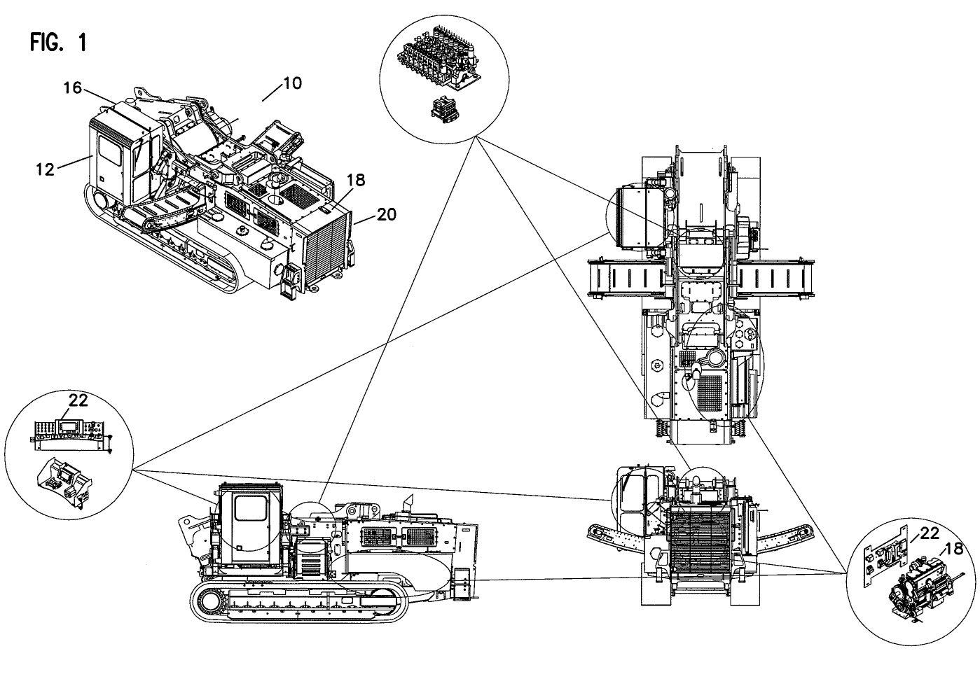

FIG. 1 identifies various trencher components and control nodes of an embodiment of the trencher control system according to the present disclosure. The layout of the components and control nodes minimizes the wiring and improves the reliability and cost of the trencher.

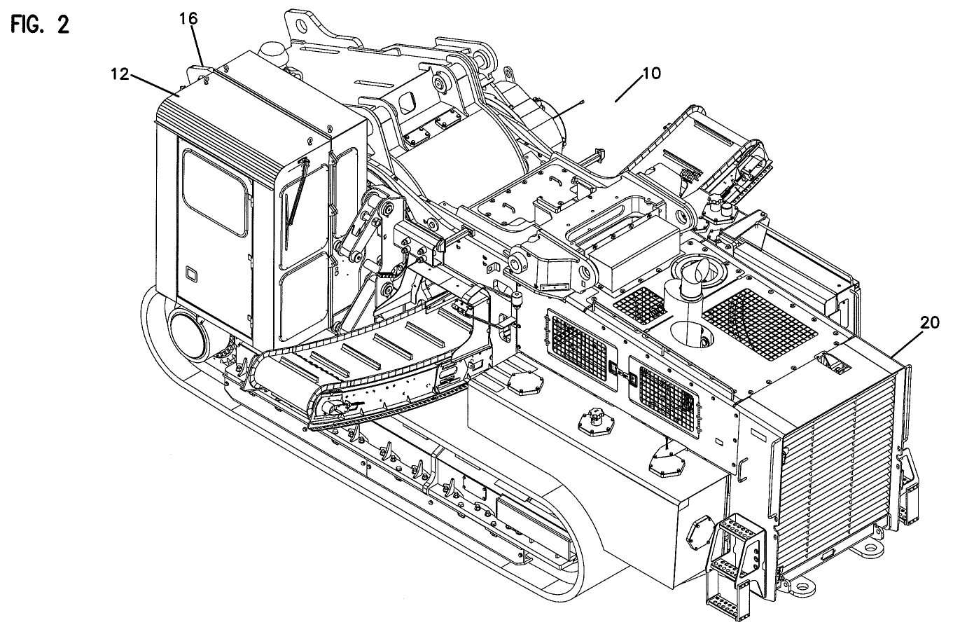

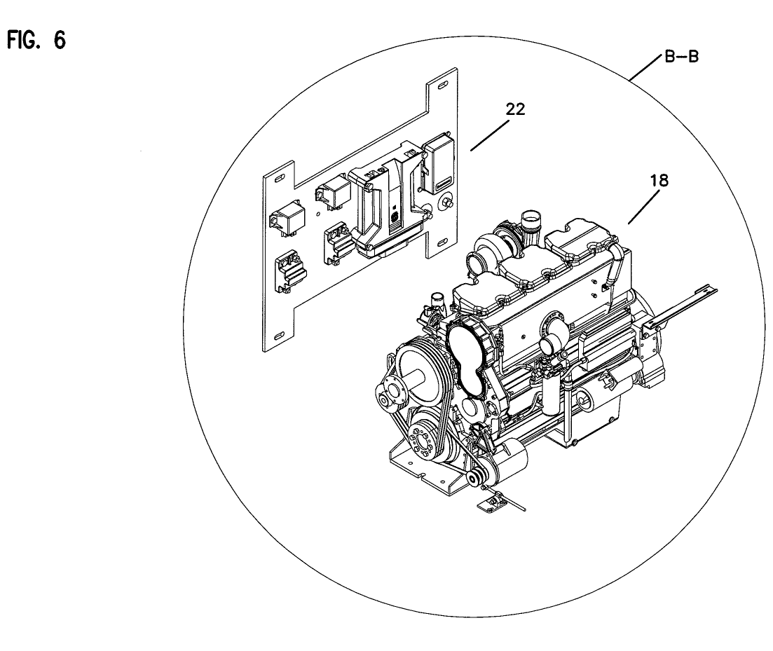

FIG. 2 is a perspective view of a trencher 10 according to the present disclosure. The trencher includes a cab 12 supported on a frame adjacent a first end 16 of the trencher 10 and an engine 18 (FIG. 6) supported on the frame at a second end 20 of the trencher 10.

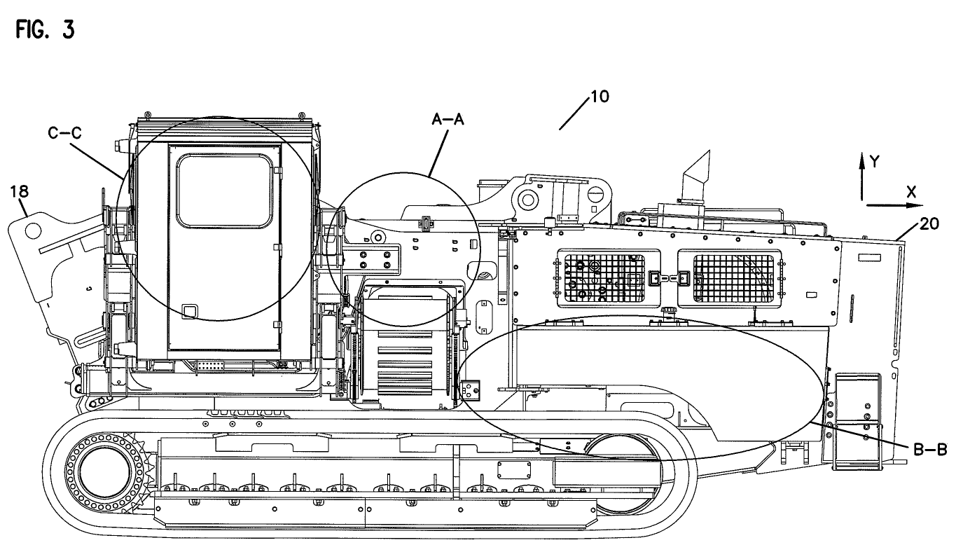

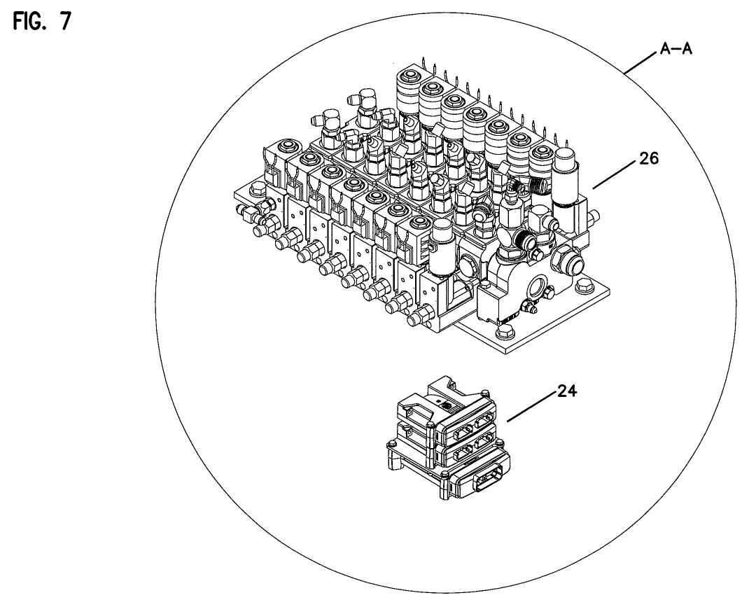

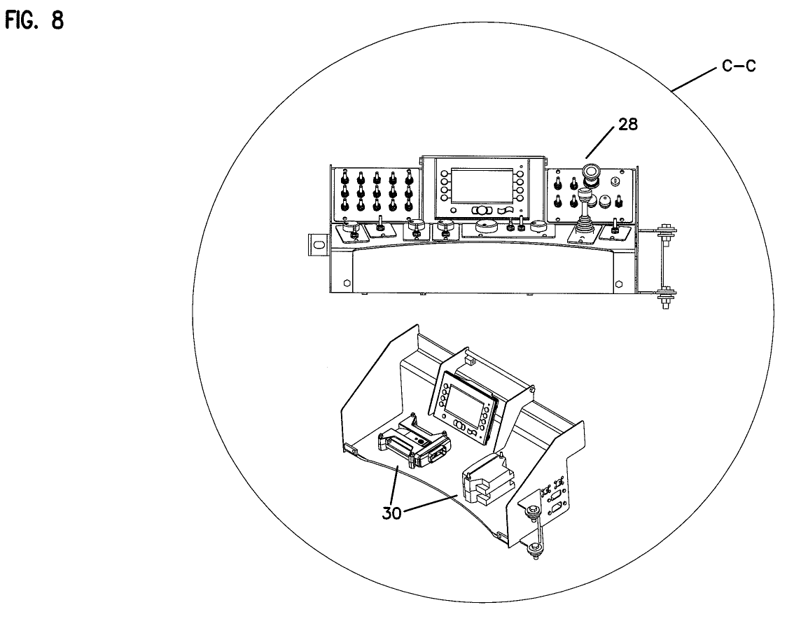

FIG. 3 is a side view of the trencher 10. Section A-A references the location of control components near the valve bank 26, which are shown in more detail in FIG. 7. Section B-B references the location of control components near the engine 18, which are shown in more detail in FIG. 6. Section C-C references the location of control components near the cab, which are shown in more detail in FIG. 8. It should be appreciated that sections A-A, B-B, and C-C in FIG. 3 show the relative vertical (Y) and front-to-back (X) positions of the control components of the trencher 10 from a side view according to an embodiment of the present disclosure. Other alternative layouts according to the present disclosure are also possible.

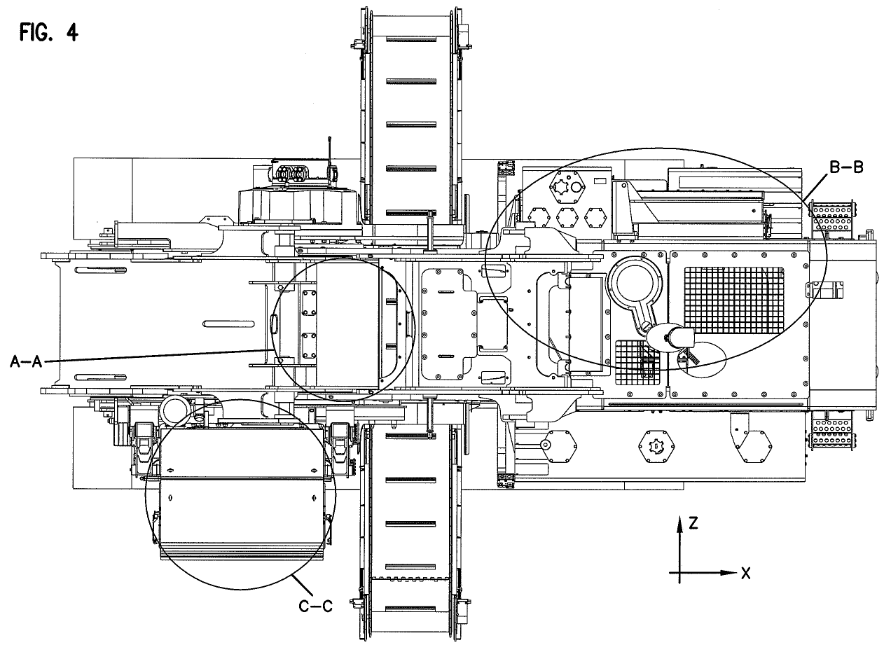

FIG. 4 is a top view of the trencher 10. Again, section A-A references the location of control components near the valve bank, which are shown in more detail in FIG. 7; section B-B references the location of control components near the engine 18, which are shown in more detail in FIG. 6; and section C-C references the location of control components near the cab, which are shown in more detail in FIG. 8. It should be appreciated that sections A-A, B-B, and C-C in FIG. 4 show the relative left-to-right (Z) and front-to-back (X) positions of the control components of the trencher 10 from a top view according to an embodiment of the present disclosure. Other alternative layouts according to the present disclosure are also possible.

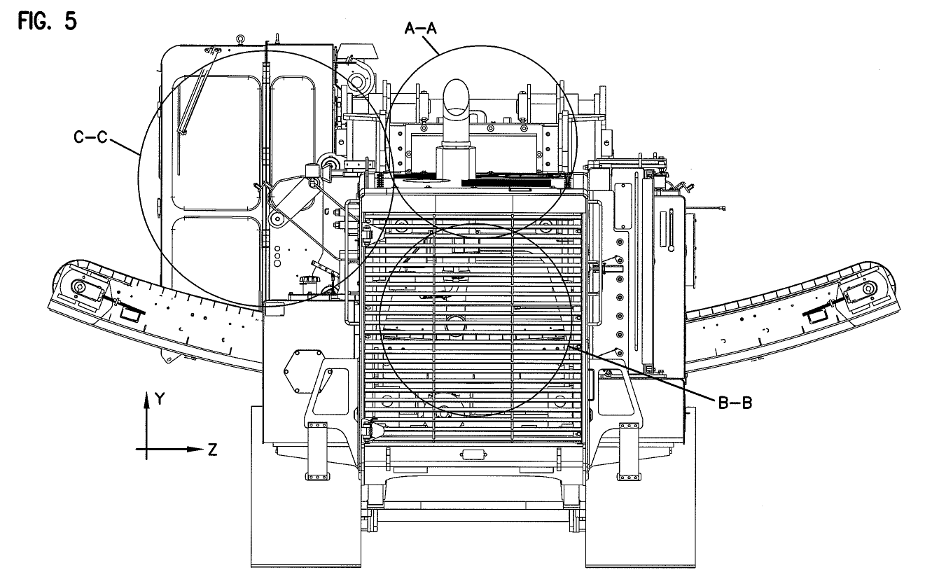

FIG. 5 is an end view of the trencher 10. Again, section A-A references the location of control components that are shown in more detail in FIG. 7; section B-B references the location of control components that are shown in more detail in FIG. 6; and section C-C references the location of control components that are shown in more detail in FIG. 8. It should be appreciated that sections A-A, B-B, and C-C in FIG. 5 show the relative left-to-right (Z) and vertical (Y) positions of the control components of the trencher 10 from an end view according to an embodiment of the present disclosure. Other alternative layouts according to the present disclosure are also possible.

FIG. 6 is a perspective view of the engine 18 and the main controller devices 22, FIG. 7 is a perspective view of a valve bank 26 and the valve controller devices 24; and FIG. 8 is a front view of a control panel (also referred to as the dash) 28 and a perspective view of the control panel/dash controllers 30. As shown in FIGS. 1-5, the control components (e.g., main controller devices 22, the valve controller devices 24, and the dash controllers 30) also referred to herein as control nodes are located near the components (drive units (engines, cylinders, pumps), sensor, etc.) that they directly control. In the depicted embodiment, each control node includes a microprocessor capable of sending and receiving control signals from the components and controlling the components based in part on such signals. For example, the main controller 22 controls the engine function based on signals received from the dash controller 30 and the valve controller 24.

In the depicted embodiments the control node that is nearest the component is the one that controls it. In the depicted embodiment the control node that is nearest the component is wired to the component. In the depicted configurations the length of the wire between the control node and the component is less than 15 feet, more preferably the wire is less than 10 feet, even more preferably the wire is less than 5 feet, and most preferably the wire is less than three feet long.

Referring to FIG. 6, the main controller devices 22 are located in section B-B near the engine 18 according to an embodiment of the present disclosure. In an embodiment, the main controller 22 is located in the battery box (not shown) of an engine compartment of the trencher 10. The main controller devices 22 are configured to receive two to four wires from each of the following functional components of the trencher 10: track speed sensors, the track drive, the track pressure sensor, the track tilt sensor, the attachment speed sensor, the attachment drive, the attachment pressure sensor, fuel sensors, hydraulic tank temperature sensors, hydraulic tank level sensor, and hydraulic charge pressure sensor. The above-listed components are typically located relatively close to the main controller devices 22; therefore, the wires from the above-identified functional components to the main controller devices 22 are relatively short. Also, central to the main controller devices 22 is the engine 18, which is connected to the main controller devices 22 via CAN (Controller Area Network) technology, which is essentially a network established among microcontrollers. The location of the controller devices 22 in section B-B allows minimal wiring. For example, instead of individual wires running between the cab 12 and the engine 18 for controlling the throttle and for gathering engine feedback (e.g., RPM, temperature, hydrostatic pressure, etc.), the present disclosure provides a system wherein only a few wires connect the controller devices 22 to the control device in the cab 12. The few wires transmit feedback and control signals from the operator to the above-identified trencher components.

Referring to FIG. 7, the valve controller devices 24 located in section A-A are near the valve bank 26. The controller devices 24 control the function of subcomponents of the trencher by controlling the distribution of hydraulic fluid through hydraulic hoses (not shown) that are connected to the valve bank 26. The directional control valves of the valve bank 26 according to an embodiment of the present disclosure control the following functions: crane lift and extend, boom lift, tilt track level and tilt, cab lift, dirt drags, crumber shoe, park brake, track speed, and attachment tilting terrain leveler. Each of the above-listed example functions typically include wires, a few running to the controller devices 24. The location of the controller devices 24 near the valve bank 26 allows each of these wires to be relatively short. According to the present disclosure, a few longer runs of non-centralized wiring are also directed to the valve controller devices 24, for example, for the accumulator, attachment charge pressure, attachment temperature sensor, attachment speed sensor, horn, back-up alarm, auto greaser, terrain level sensor, and conveyor drives.

Referring to FIG. 8, a front view of a dash 28 and perspective view of the dash controller devices 30 located in section C-C are shown. The control panel/dash controller devices 30 are located in the dash 28, which is located in the cab 12. In an embodiment of the present disclosure the dash controller devices 30 are connected to wiring from the following: propel handle that controls the tracks; attachment switch and knob that control the attachment; conveyor switches and knobs that control the conveyor; steering knob that controls the tracks; load control knob that controls the boom, attachment and track with respect to the engine RPM; mode switches that control the track and attachment; crane switches that control a crane attachment; boom control switches that control the boom lift, which is a hydraulic valve function; tilt track switches that control the tilt track, which is a hydraulic valve function; cab movement switches that control the cab lift, which is a hydraulic function; dirt drag switch that controls the dirt drags, which is a hydraulic function; crumber shoe switch that controls the crumber shoe, which is a hydraulic function; park brake switch which controls the park brake, which is a hydraulic function; E-stop which controls all power; key that controls all power and the starter; horn switch that controls the horn, and throttle switch that controls the engine throttle. Each of the above devices is generally referred to herein as user interface devices. Also, each of these devices typically uses two to six wires. The location and layout of the dash controller devices 30 keep each of these wires as short as possible. According to the present disclosure, the wires run between the user interface and the dash controller devices 30 instead of from the user interface to the devices themselves.

In the disclosed embodiment the control system consists of two or more microprocessors connected via CANbus wires that feed information to each other. An advantage of the CANbus is that it only requires two shielded wires to communicate, instead of separate wires for each function. In an alternative embodiment the signals that would otherwise be transmitted via the shielded wires are, instead, communicated to the control panel wirelessly. Accordingly, the disclosed layout streamlines the control and feedback signals to and from the cab, thereby making it feasible to remove the control panel from the cab to control the trencher remotely.

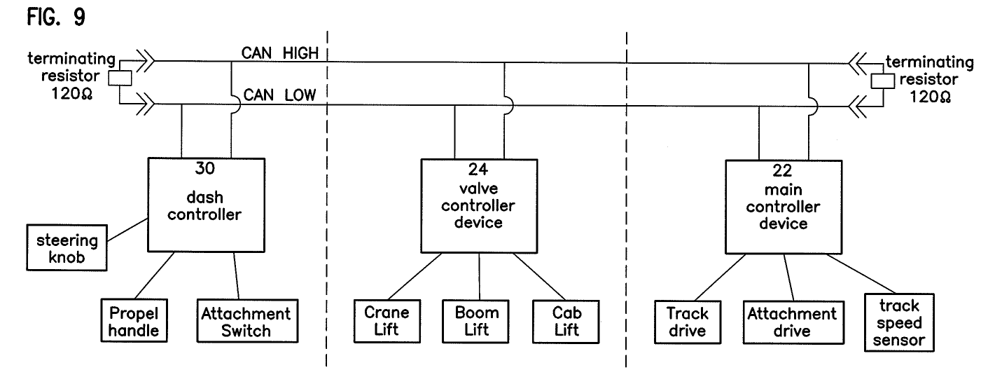

Referring to FIG. 9, an example of the above-described wiring configuration is shown in more detail. In the depicted arrangement, each of the controllers 30, 24, 22 are connected to a CAN High and CAN Low line for communication. As discussed above, each of the controllers 30, 24, 22 are also wired to the components that are local to the controllers 30, 24, 22. For example, the dash controller 30 is shown wired to the steering knob, the propel handle, and the attachment switch. The valve controller 24 is shown wired to the crane lift, the boom lift, and the cab lift. The main controller 22 is shown wired to the track drive, the attachment drive, and the track speed sensor.

In the depicted configuration, the microprocessors in each of the controllers are able to communicate directly to each other. For example, the dash controller 30 can send a control signal from the propel handle to the main controller 22 relating to the desired function of the attachment drive (e.g., drive forward), and the main controller 22 can also send and receive signals from the valve controller 24 based on the received control signal regarding the desired function of the attachment drive (e.g., requesting information regarding the position of the boom). The main controller 22 can then determine if the desired function can be carried out and in what manner (e.g., the forward drive speed may be limited by the position of the boom). The ability of each of the controllers to directly communicate with the other controllers about the components that it is wired to enables the system to operate efficiently with very few wires. This simplified wiring layout provides many advantages (e.g., reliability, relatively easy to maintain, fast communications, relatively easy to install, relatively easy to modify the machine, etc.).

The above specification, examples and data provide a complete description of the manufacture and use of the composition of the invention. Since many embodiments of the invention can be made without departing from the spirit and scope of the invention, the invention resides in the claims hereinafter appended

We claim:

1. A trencher comprising:
a chassis having a first end portion and a second end portion;
a cab supported at a first end portion of the chassis, such that the cab can be moved up and down relative to the chassis;
an engine supported at the second end portion of the chassis;
a hydraulic fluid valve bank supported between the cab and the engine;
a first control node wired to at least one user interface device;
a second control node wired to the engine;
a third control node wired to the hydraulic fluid valve bank;
wherein the first control node, second control node, and third control node are operably connected by wires such that a control signal from the first node can be sent to the second node and the second control node can receive control signals from the third node.

2. The trencher of claim 1, wherein the first and third control nodes are not directly wired to the engine, wherein the second and third control nodes are not directly wired to the at least one user interface device, wherein the first and second control nodes are not directly wired to the hydraulic fluid bank.

3. The trencher of claim 1, wherein the wires that connect the first control node to the user interface, the wires that connect the second control node to the engine, and the wires that connect the third control node to the hydraulic fluid valve bank are each less than ten feet long.

4. The trencher of claim 3, wherein the wires that connect the first control node to the user interface, the wires that connect the second control node to the engine, and the wires that connect the third control node to the hydraulic fluid valve bank are each less than five feet long.

5. The trencher of claim 3, wherein less than six wires connect the first control node to the second or third control nodes.

6. The trencher of claim 4, wherein less than two wires connect the first control node to the second or third control nodes.

7. A trencher comprising:
a chassis having a first end portion and a second end portion;
a cab supported at a first end portion of the chassis;
an engine supported at the second end portion of the chassis;
a hydraulic fluid valve bank supported between the cab and the engine;
a first control node located within the cab;
a second control node wired to the engine;
a third control node wired to the hydraulic fluid valve bank;
wherein the first control node is operably connected to the second and third control nodes.

8. The trencher of claim 7, wherein the cab is configured to be raised and lowered relative to the chassis.

9. The trencher of claim 7, wherein the first control node is only connected to the hydraulic fluid valve bank or engine through the second and third control nodes.

10. The trencher of claim 7, wherein the first control node is wired to at least one of the following: a propel handle, an attachment control knob, a conveyor switch, a steering knob, a load control knob, a cab movement switch, a dirt drag switch, a crumber shoe switch, or a track tilt switch.

11. The trencher of claim 7, wherein the second control node is wired to at least one of the following: track speed sensors, the track pressure sensor, the track tilt sensor, the attachment speed sensor, the attachment drive, the attachment pressure sensor, fuel sensors, hydraulic tank temperature sensors, hydraulic tank level sensor, or hydraulic charge pressure sensor.

12. The trencher of claim 7, wherein the third control node is wired to at least one of the following: a crane lift unit, a boom lift unit, a track tilt unit, a cab lift unit, dirt drags, a crumber shoe, a park brake, track speed sensors, or a terrain leveler.

13. The trencher of claim 7, wherein a wire connecting the engine to the second control node is less than five feet long.

14. The trencher of claim 13, wherein a wire connecting the engine to the second control node is less than three feet long.

15. The trencher of claim 1, wherein a wire connecting the hydraulic fluid valve bank to the third control node is less than five feet long.

16. The trencher of claim 15, wherein a wire connecting the hydraulic fluid valve bank to the third control node is less than three feet long.

17. The trencher of claim 1, wherein less than six wires connect the first control node to the second or third control nodes.

18. The trencher of claim 17, wherein less than two wires connect the first control node to the second or third control nodes.

19. The trencher of claim 12, wherein no wires connect the first control node to the second or third control nodes.

20. A method of wiring a trencher comprising:
mounting a first control node, second control node, and third control node to a trencher;
wiring the first, second, and third control nodes to each other;
wiring a plurality of sub components to only one of the first, second, or third control nodes, wherein the subcomponent include at least an engine and a hydraulic fluid valve bank and wherein the engine and hydraulic fluid valve bank are connected to the nearest control node.
